(19) United States
(12) Patent Application Publication
(10) Pub. No.: US 2006/0278322 A1
(43) Pub. Date: Dec. 14, 2006

(54) Shaping of air permeable structural members with thermoplastic binders

(76) Inventors: Reimund Piatkowski, Dortmund (DE); Norbert Nicolai, Schermbeck (DE); Herbert Reisinger, Wuppertal (DE); Willi Peterkord, Bochum (DE)

Correspondence Address: HARNESS, DICKEY & PIERCE, P.L.C., P.O. BOX 828, BLOOMFIELD HILLS, MI, 48303, US

(21) Appl. No.: 10/567,600

(22) PCT Filed: Jul. 30, 2004
(86) PCT No.: PCT/EP04/08559

§ 371 Date: Aug. 21, 2006

(30) Foreign Application Priority Data
Aug. 5, 2003 (DE) 103-35.721.1

(51) Int. Cl. B29C 47/00

(52) U.S. Cl. 156/62.2; 156/245; 264/122

(57) ABSTRACT

The present invention relates to the shaping of mixtures of thermoplastic binders with fibers, foam, granules etc. The shaped air- or steam-permeable materials are heated by means of steam and subsequently cooled down by applying a vacuum and evaporating the condensate obtained during the heating, so that the shape impressed by the mold is permanently retained. For performing the process, the mold must have particular properties.

The present invention relates to the shaping of mixtures of thermoplastic binders with fibers, foam, granules etc.

Structural members made from fibrous main components are heated by means of steam in order to minimize the cycle times. Thus, structural members in which a phenol resin is employed as the binder are shaped in a hot-pressing mold, and the heat required for the chemical reaction is conveyed into the structure of the structural member by means of steam.

For structural members comprising thermoplastic binders, a non-woven sheet is usually prepared which is heated on a plate by contact, or it is open towards the environment, and steam flows through to heat it.

Subsequently, the heated material is shaped in a compression mold and cooled in the cold mold. This process is employed in a batch mode for the shaping of sheet blanks, or in a continuous process for the preparation of plates, DE 698 01 228 T2.

In another process, hot air is flowed through the shaped material which is thus heated and subsequently cooled by cold air flowing through, DE 3625818 C2.

The principle of heat dissipation by the evaporation of liquids is extensively applied in refrigeration technology. Water is also employed as a heat-transfer medium today, although less frequently than at the beginning of the utilization of this technology. In this case, the evaporation of the water is mostly effected under vacuum in order that the heat can be transferred on a low temperature level.

In industrial processes, a vacuum is widely employed for the drying of materials, e.g., wood, DE 198 22 355 A1. The material is placed into a pressure-resistant chamber. In the chamber, a vacuum is applied, and the moisture contained in the material is evaporated. The heat required for evaporation is continuously supplied from outside.

DE 199 07 279 A1 describes an automated molding device for the preparation of plastic foam products from beads, comprising a mold cavity into which the beads are placed and pressurized with a gaseous heat-transfer fluid, especially hot steam, wherein said gaseous heat-transfer fluid enters the mold cavity from one surface of the automated molding device and leaves through another surface of the automated molding device, characterized in that a fabric is present at the inlet and/or at the outlet.

WO 97/04937 describes a method for bonding a cover fabric to a cushion body for producing a seat cushion for a seating component by supplying steam under pressure to a forming tool, the forming tool diffusing the steam and passing the steam out of the tool and through the cover fabric and into the cushion body, wherein the forming apparatus, the cover fabric and the cushion body are located in a pressure chamber which is maintained at relative high pressure so that the bonding process can be carried out in a pressurized environment.

When molded parts are prepared from polystyrene, a cavity is filled with pre-expanded polystyrene beads. Subsequently, steam heats the beads. The supplied heat causes an expanding agent present in the beads to evaporate, whereby the bead expands further. This causes a pressure with which the beads are pressed together and against the wall, whereby they become fused together. To release the pressure at the end of the process, water is sprayed on, and in some cases, a vacuum is applied.

It is the object of the present invention to heat and cool down again within a short period of time an air- and steam-permeable structural member 4 comprising fibrous main components with thermoplastic binders and having a low density and a thickness of the material of from 5 to 150 mm, without substantially changing the material composition of the structural member.

In a first embodiment, the above object is achieved by a process for preparing and/or setting air- and steam-permeable structural members 4 containing a mixture of thermoplastic binder and natural fibers and/or artificial fibers with or without additional foam in the form of flakes and/or granules, characterized in that said structural member 4 in a pressure-resistant chamber between shaping surfaces with a low or no heat transfer to or from the mold, after deaerating the chamber by applying a vacuum within a range of from 0.5 to 0.01 bar absolute, is pressurized by a vaporous heat-transfer medium within a pressure range of from 2 to 10 bar absolute, and in a further process step, a vacuum is applied within a range of from 0.5 to 0.1 bar absolute to evaporate the condensed heat-transfer medium.

In contrast to the prior art, the invention described herein utilizes a heat-transfer medium in a vaporous state of matter, especially steam, for the shaping of fibers and foams with fusible binders, the essential advantage being that the heat transfer for heating is effected through the condensation of the steam, and the condensate essentially remains in the place where it is utilized for cooling by means of evaporation in the subsequent process step.

It is required to adapt the mold employed to the material and the process. A cold mold causes an extensive condensation with heat transfer at the mold during the steam-supplying phase. The excess condensate is taken up by the structural member and cannot be removed from the material within a sufficiently short time by applying a vacuum.

When the mold is too hot, the molded part which is cold inside from the evaporation cooling will adhere to the hot mold surface.

Therefore, according to the invention, the structural member is contacted with a mold having a low thermal conductivity and/or low heat capacity, whereby the heat transfer to and/or from the mold during the cycle is limited to a maximum of 250 m²/s² per 1 m² of surface of the structural member and per 1 K of heating of the structural member during the process.

In a further preferred embodiment of the present invention, a structural member 4 consisting of at least one layer, especially two or more layers, of the same or different material compositions.

According to the present invention, it is further preferred to employ a contour-defining thin shell of a perforated and/or non-perforated metal sheet having a low heat capacity and a steam-impermeable solid mold base with a steam-channeling space between as a mold for shaping.

According to the present invention, it is particularly preferred for the metal sheet to be at a distance of from 2 to 20 mm from the mold base. Alternatively, it is possible to employ a layer of a material having a low thermal conductivity, especially PTFE, EPDM, epoxy resin or phenolic resin, applied to the mold base in a layer thickness of from 1 to 30 mm as a shaping contour.

The mold design as described in the present invention achieves that the shaping surface takes up little heat, and thus little additional condensate is obtained in the molded part. At the same time, the surface cools down sustainably during the evaporation cooling, which facilitates the release of the molded part from the mold.

According to the present invention, it is particularly preferred to employ a pressure-resistant mold base made of a processed solid material, especially aluminum or steel, alternatively also of a processed cast material, especially of grey cast iron or cast aluminum.

Common to all variants of the adapted molds of this invention is the heated base by which the condensation at the base is kept low.

The selection of the liquid heat-transfer medium depends on the desired situation. According to the present invention, it is particularly preferred to employ heat-transfer oil or heating water as the heat-transfer medium flowing through bores or pipe coils for bringing the temperature to from 120 to 180° C.

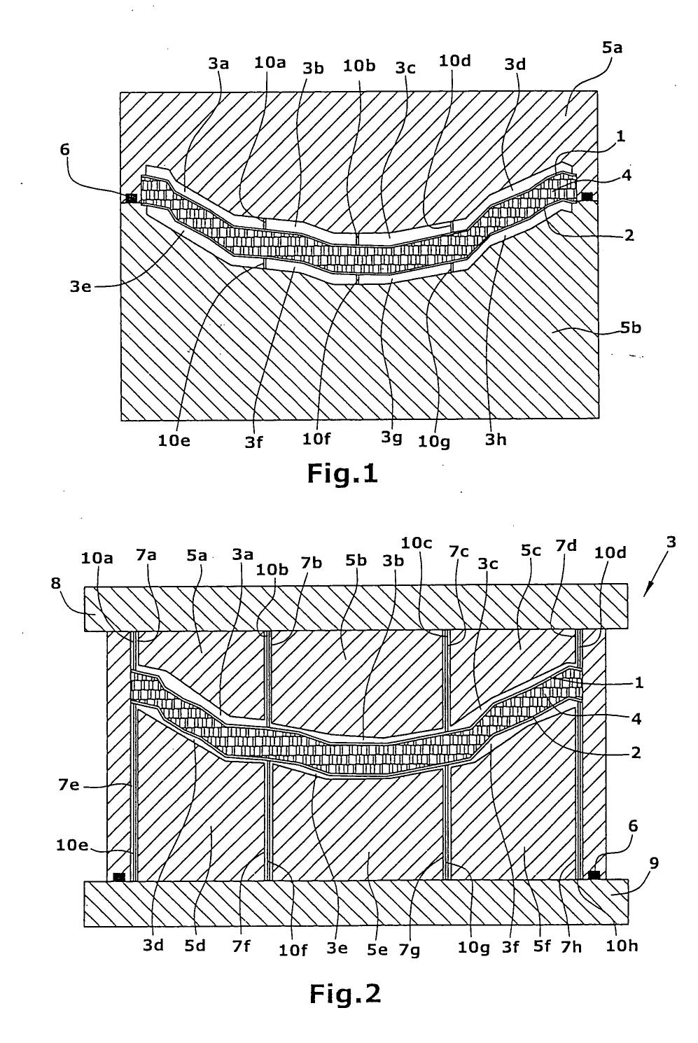

In variant A, see FIG. 1, the shaping mold consists of two thin perforated metal sheets 1, 2 which are attached to a metal sheet frame supported by web plates 10a-10g. Cavities existing behind the shaping contour are filled with adapted packings 5a-5b, except for a gap for steam conduction 3a-3h. The packings can be heated and/or cooled by deep bores 7a-7k.

The mold is mounted in a pressure-resistant case 8, 9 and 12, so that the mold contained therein which consists of an upper tool and a lower tool can be opened when the case is opened or thereafter, and the structural member 4 can be inserted and withdrawn.

For example, the case is standing on heatable plates (not shown), or it is heated by a heat-transfer medium flowing in deep bores of the case.

In the closed case, the structural member 4 is brought into its final shape. The supplied steam flows into the cavities behind the shaping metal sheets 1, 2 into the air-permeable structural member 4 and heats the material past which it flows. Steam condenses at the surface of the material, and the condensation heat enhances the temperature of the material to the steam temperature.

The metal sheets 1, 2 have a low heat capacity. Little condensate forms at the shaping surface and permeates into the outer layers of structural member 4.

When a vacuum is applied, the condensate adhering to or taken up by the material of the structural member 4 evaporates with absorption of heat. The energy is carried away with the steam. The condensate resulting from the heating of the mold is present in the outer layers. The heat required for the evaporation is withdrawn from the previously heated metal sheets 1, 2. Thus, the metal sheets 1, 2 cool down more than the mold base which consists of the web plates 10a-10g and wall sheets 1, 2 and the packings 5a-5b and towards which a heat-insulating gap (from 2 to 20 mm) exists.

As a result, a cooled-down dry structural member 4 is obtained which is readily released from the mold (sheets 1, 2).

Variant B of the shaping mold according to the invention consists of a two-part mold 5 made from blocks 5a-5f, FIG. 2. The mold 5 also has an external seal 6. It can be heated directly via deep bores (not shown) or pipe coils in the base 5a-5f through which a heat-transfer medium flows, or it is heated indirectly by heated mounting plates.

The contour is shaped into the blocks of the base 5a-5f, but deeper by 2 to 20 mm than required for the geometry of the parts. The contouring surface shaped from metal sheets 1, 2 is attached thereto through spacers 10a-10h. At least one of the two metal sheets 1, 2 is perforated. Through one or more bores in the base 5a-5f, the steam is supplied to and withdrawn from the cavity 3a-3f between the perforated metal sheets 1, 2 and the mold base 5a-5f. The properties of this variant are the same as those of variant A.

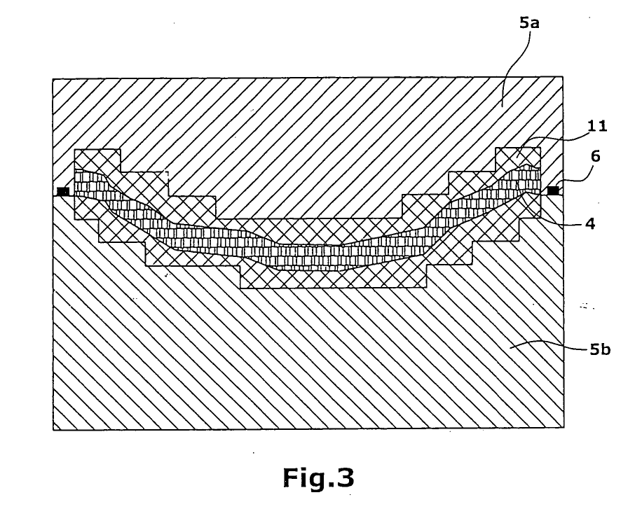

Variant C has a mold base 5a, 5b much like variant B, FIG. 3. A material 11 having a low thermal conductivity is applied to the recessed contour of the base 5a, 5b, and preferably, the thermoplastic binders of structural member 4 also have a low adhesion to said material 11. In this variant, the restriction of the condensation on the mold according to the invention is achieved by impeding the heat transport from the shaping surface into the firmly attached base 5a, 5b. Due to the low adhesion of the fusible component and the shaping surface, a higher surface temperature can be accepted, so that less condensate from condensation on the mold 5a, 5b occurs in the working cycle.

1-9. (canceled)

10. A process for preparing and/or setting air and steam-permeable structural members containing a mixture of thermoplastic binder and fibers, optionally with additional foam in the form or flakes and/or granules, said process comprising the steps of:
(a) positioning a structural member between shaping surfaces in a pressure resistant chamber of a mold having upper tool and lower tool portions;
(b) deaerating the chamber by applying a vacuum;
(c) pressurizing said vacuum chamber with a vaporous heat-transfer medium; and
(d) applying a vacuum to said chamber to evaporate the condensed heat-transfer medium.

11. The process according to claim 10, wherein the heat transfer per unit mass of the structural member between the vaporous heat-transfer medium and the pressure resistant chamber is lower than 250 m²/s² per 1 m² of surface of the structural member and per 1 K of heating the structural member.

12. The process according to claim 10, wherein the structural member has at least two layers.

13. The process according to claim 12 wherein said layers are of different materials.

14. The process according to claim 10 wherein said shaping surfaces are perforated metal sheets spaced apart from said pressure resistant chamber thereby defining a steam channeling space.

15. The process according to claim 14 wherein said metal sheets are disposed at a distance of from about 2 to about 20 mm from said pressure resistant chamber.

16. The process according to claim 10 wherein the shaping surfaces comprise a layer of material having a low thermal conductivity.

17. The process according to claim 16 wherein said sheets have a layer thickness of from about 1 to about 30 mm.

18. The process according to claim 16 wherein said layer of material is selected from the group consisting essentially of PTFE, EPDM, epoxy resin or phenolic resin.

19. The process according to claim 10 wherein said upper and lower mold tools include contoured blocks which form the mold base.

20. The process according to claim 19 wherein said contoured blocks are formed from a material selected from the group consisting essentially of aluminum steel, cast iron or cast aluminum.

21. The process according to claim 19 wherein said mold bases are heated to a temperature to between about 120° to 180° C.

22. A process for preparing and/or setting air and steam-permeable structural members containing a mixture of thermoplastic binder and fibers, optionally with additional foam in the form or flakes and/or granules, said process comprising the steps of:
(a) positioning a structural member between shaping surfaces in a pressure resistant chamber of a mold having upper tool and lower tool portions;
(b) deaerating the chamber by applying a vacuum within a range of from 0.5 to 0.01 bar absolute;
(c) pressurizing said vacuum chamber with a vaporous heat-transfer medium within a pressure range of from 2 to 10 bar absolute; and
(d) applying a vacuum to said chamber to evaporate the condensed heat-transfer medium within a range of from 0.5 to 0.1 bar absolute.

23. The process according to claim 22, wherein the structural member has at least two layers.

24. The process according to claim 23 wherein at least two of said layers are of different materials.

25. The process according to claim 21 wherein said shaping surfaces are perforated metal sheets spaced apart from said pressure resistant chamber thereby defining a steam channeling space, said sheets being disposed at a distance of from about 2 to about 20 mm from said pressure resistant chamber.

26. The process according to claim 21 wherein the shaping surfaces comprise a layer of material having a low thermal conductivity, said sheets applied to the mold chamber in a layer thickness of from about 1 to about 30 mm.

27. The process according to claim 21 wherein said upper and lower mold tools include contoured blocks which form mold bases.

28. The process according to claim 27 wherein said contoured blocks are formed from a material selected from the group consisting essentially of aluminum, steel, cast iron or cast aluminum.

29. The process according to claim 27 wherein said mold bases are heated to a temperature to between about 120° to 180° C.
